(19) United States
(12) Patent Application Publication
(10) Pub. No.: US 2005/0053672 A1
(43) Pub. Date: Mar. 10, 2005

(54) Synergistic metal salt-cationic surfactant-organic biocide composition

(76) Inventor: Michael Howard West, Senatobia, MS (US)

Correspondence Address: MICHAEL HOWARD WEST, 54 SOUTH CROCKETT ROAD, SENATOBIA, MS, 38668, US

(21) Appl. No.: 10/657,030

(22) Filed: Sep. 8, 2003

(51) Int. Cl. A01N 59/16; A01N 59/06

(52) U.S. Cl. 424/617; 424/682; 424/646; 424/639

(57) ABSTRACT

A biocide composition comprising (a) about 0.05% to about 75% of an acidic metal salt selected from the metal group consisting of aluminum, iron, manganese, and zirconium; (b) about 0.05% to about 75% of a cationic surfactant; and (c) about 0.0001% to about 25% of an organic biocide.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The field of endeavor to which this invention pertains relates to the control of biological organisms which are destructive to materials, production processes, health , or environment. Problems solved by my invention include poor performance and excess usage of organic biocides. Specifically the synergistic biocide I teach is a composition comprising
(a) about 0.05% to about 75% of an acidic metal salt selected from the metal group consisting of aluminum, iron, manganese, and zirconium;
(b) about 0.05% to about 75% of a cationic surfactant; and
(c) about 0.0001% to about 25% of an organic biocide.

The metal salts I teach are seldom encountered in the biocide literature. Cationic surfactants and organic biocides are frequently mentioned together in the literature. The cationic surfactants sometimes exhibit biocide activity even when used alone.

Examples of metal salts useful in the practice of my invention are the chlorides and the nitrates. Cationic surfactants which are especially helpful are the amine salts, quaternary ammonium salts, and the alkoxylated amines. It would be futile to list organic biocides to use in my invention for new ones are being introduced almost daily.

The synergistic combination of my invention targets destructive fungi, bacteria, and insects. However, it may repel, or render harmless, larger or smaller organisms. The metals have little toxicity. In fact aluminum and iron are the third and fourth most common elements in our environment. It is believed the metals of my invention are fixed by the cationic surfactants to physically block various growth and reproductive processes of harmful organisms. Nonetheless, an organic biocide is necessary to prevent the harmful organisms from circumventing this blocking action.

### BRIEF SUMMARY OF THE INVENTION

The present invention relates to a synergistic biocide composition comprising
(a) about 0.05% to about 75% of an acidic metal salt selected from the metal group consisting of aluminum, iron, manganese, and zirconium;
(b) about 0.05% to about 75% of a cationic surfactant; and
(c) about 0.0001% to about 25% of an organic biocide.

The object of my invention is to use less biocides with greater control of harmful organisms.

### DETAILED DESCRIPTION OF THE INVENTION

The preferred embodiment of my invention for illustrating synergism employs an ethoxylated diamine wherein the alkyl groups are 12 to 14 carbons, and the ethoxylation sufficient to provide water solubility. This cationic surfactant exhibits little biocidal activity, and the improved performance of the combination is more easily understood. The preferred embodiment employs polyvalent aluminum chloride for reasons of economics along with few hazards to human health. Propiconazole is chosen as the preferred organic biocide because of few hazards to human health and the environment, and because of approvals from Regulatory Agencies. To confirm synergism in the practice of my invention an aqueous dilution was mixed from commercial raw material to contain 0.1% polyaluminum chloride, 0.1% ethoxylated diamine, and 0.0001% propiconazole. Simple mixing is all that is required to prepare the preferred composition of my invention. This composition, along with aqueous dilutions of each of the components, at twice their concentration in the combination, were tested by inoculation with a fungal slime. Only the combination biocide according to my invention inhibited the growth of this slime.

It will be understood by those skilled in the art that formulation ingredients such as defoamers, penetrants, water repellents, etc. may be added to the composition of my invention providing they do not destroy its performance.

1. A biocide composition comprising
(a) about 0.05% to about 75% of an acidic metal salt selected from the metal group consisting of aluminum, iron, manganese, and zirconium;
(b) about 0.05% to about 75% of a cationic surfactant; and
(c) about 0.0001% to about 25% of an organic biocide.

2. A composition according to claim 1 wherein the acidic metal salt is polyaluminum chloride.

3. A composition according to claim 1 wherein the cationic surfactant is an amine salt.
